(19) United States
(12) Patent Application Publication
(10) Pub. No.: US 2021/0212508 A1
(43) Pub. Date: Jul. 15, 2021

(54) SMOKELESS BAKING TRAY

(71) Applicant: LIPING WANG, FOSHAN CITY (CN)

(72) Inventor: YAN DU, FOSHAN CITY (CN)

(21) Appl. No.: 16/996,143

(22) Filed: Aug. 18, 2020

(30) Foreign Application Priority Data
Jan. 9, 2020 (CN) 202010023180.0

(51) Int. Cl. A47J 37/07; A47J 37/06

(52) U.S. Cl. CPC A47J 37/0754; A47J 37/0664

(57) ABSTRACT

A smokeless baking tray is provided, comprising a baking tray main body, a fan assembly and a control assembly. A pull-out sliding filter tray and a pull-out bracket are provided on the baking tray main body. First limiting portion is provided on the baking tray main body and second limiting portion is provided on the pull-out bracket. First sliding gap is between the first and second limiting portions. Side wing is provided on the filter tray and slides in the first sliding gap, and is supported on the first limiting portion. The second limiting portion acts limiting function on the top of the side wing. The fan assembly and the control assembly are respectively and detachably arranged on the baking tray main body. The fan assembly comprises a motor and an electrical connection male connector. The control assembly comprises a control main board and an electrical connection female connector.

### FIELD OF THE DISCLOSURE

The present disclosure relates to a kitchen appliance, in particular to a smokeless baking tray.

### BACKGROUND OF THE DISCLOSURE

In the existing smokeless baking tray on the market, it is generally necessary to set a water filter tray to filter and absorb the oil smoke; the existing water filter tray is generally placed directly inside the smokeless baking tray, and the heating part, the baking tray and other parts need to be disassembled before placing the water filter tray. The assembly of the traditional water filter tray cannot be completed individually, the operation is very troublesome, and the user experience is poor. In addition, the smokeless baking tray will be dirty after long-term use, and users need to clean and maintain it regularly. However, due to the integration of a variety of non-detachable electrical members on the traditional smokeless baking tray, special care must be taken when doing the cleaning. The internal electrical members are exposed to water, which increases the difficulty of cleaning and maintenance, and the cleaning effect is not good; in addition, if the user forgets to unplug the power cord during the cleaning process, it is prone to electric shock accidents, which poses great safety risks.

### SUMMARY OF THE DISCLOSURE

The purpose of the present disclosure is to overcome the shortcomings of the above-mentioned prior art, and provide a new type of smokeless baking tray, which has the technical features of convenient and quick disassembly and assembly of the filter tray, effective prevention of electric shock accidents, improved safety factor, and convenient cleaning and maintenance.

The technical solutions provided by the present disclosure are achieved as follows.

A smokeless baking tray is provided, comprising a baking tray main body, and a fan assembly and a control assembly that are electrically connected to each other; wherein: a pull-out sliding filter tray and a pull-out bracket are provided on the baking tray main body; a first limiting portion is provided on the baking tray main body and a second limiting portion is provided on the pull-out bracket, a first sliding gap is between the first limiting portion and the second limiting portion; a side wing is provided on the pull-out sliding filter tray and slides in the first sliding gap along with the pull-out sliding filter tray; the side wing is supported on the first limiting portion and the second limiting portion acts a limiting function on the top of the side wing; the fan assembly and the control assembly are respectively and detachably arranged on the baking tray main body, wherein the fan assembly comprises a motor and an electrical connection male connector that are electrically connected to each other; the control assembly comprises a control main board and an electrical connection female connector that are electrically connected to each other; when the control assembly is assembled on the baking tray main body, the electrical connection male connector and the electrical connection female connector are plugged into each other to embody the electrical connection of the motor and the control main board; when the control assembly is separated from the baking tray main body, the electrical connection male connector is separated from the electrical connection female connector, and the motor is powered off.

A fan assembly accommodating cavity for accommodating the fan assembly is provided on baking tray main body, wherein the fan assembly further comprises a fan assembly housing, and a sealing member is provided on the fan assembly housing, and the fan assembly housing is sealed and tightly matched with the fan assembly accommodating cavity by the sealing member.

A wind wheel in position for rotating is provided on the fan assembly housing, and an air inlet and an air outlet in communication with the wind wheel are provide at a side of the fan assembly housing; the motor is fixedly arranged on the fan assembly housing, and an output shaft of the motor is connected to the wind wheel in transmission; an air inlet groove in communication with the air inlet and an air outlet groove in communication with the air outlet are provided on the fan assembly accommodating cavity; and the air inlet groove and/or the air outlet groove are provided with an oil smoke filter layer.

A pull-out sliding filter tray and a pull-out bracket are provided on the baking tray main body, and the pull-out bracket is provided on the pull-out sliding filter tray. A first limiting portion is provided on the baking tray main body and a second limiting portion is provided on the pull-out bracket, and a first sliding gap is between the first limiting portion and the second limiting portion. A side wing is provided on the pull-out sliding filter tray and slides in the first sliding gap along with the pull-out sliding filter tray; the side wing is supported on the first limiting portion and the second limiting portion acts a limiting function on the top of the side wing.

A third limiting portion is provided on the pull-out bracket, and a second sliding gap is between the first limiting portion and the third limiting portion; a folded edge is at an end of the side wing and slides in the second sliding gap along with the pull-out sliding filter tray; and the first limiting portion acts a limiting function at an inner side of the folded edge and the third limiting portion acts a limiting function at an outer side of the folded edge.

More than one connecting member is provided on the baking tray main body, and installation grooves are correspondingly provided to the connecting member; the connecting member is at least partially detachably inserted into the installation groove to embody detachable assembly of the connecting member and the baking tray main body; the connecting member is used independently, or fitted to and hinged with a corresponding cover, and the cover is hinged with the baking tray main body by a fitted connecting member.

A detachable reflecting tray and a safety switch with a certain degree of freedom of movement are provided on the baking tray main body; the control assembly also comprises a micro switch for controlling power-on/power-off state of an internal circuit; and the reflecting tray touches a switch key on the micro switch through the safety switch to make the internal circuit enter the power-on state.

The safety switch is positioned and rotated relative to the baking tray main body, the reflecting tray is pressed to act on one end of the safety switch, and the other end of the safety switch is pressed to act on the switch key; a convex shaft rotatably connecting the baking tray main body is provided on a middle part of the safety switch, and a protrusion pressed by the reflecting tray is provided on one end of the safety switch and a pin for triggering the switch key is provided on the other end of the safety switch.

A cushion block is arranged between the reflecting tray and the baking tray main body, the reflecting tray is detachably supported on the cushion block, and the reflecting tray is not in contact with the baking tray main body.

The cushion block comprises a plug-in portion, a supporting portion and a blocking portion; an installation hole is provided on the baking tray main body, the plug-in portion is inserted into the installation hole; an extension edge on the reflecting tray is supported on the supporting portion; and the blocking portion is located between an outer wall of the reflecting tray and an outer wall of the installation hole.

The smokeless baking tray of the present disclosure is further provided with a baking plate, wherein a handle that is capable of moving up and down freely is provided on the baking plate; the handle at least rises to a position suitable for the user to lift relative to the baking plate when the baking plate is lifted, and the handle is at least lowered to a position that does not hinder user's actions relative to the baking plate when the baking plate is used.

The beneficial effects of the present disclosure are as follows.

The filter tray is opened and closed by a pull-out manner, and the filter tray can be operated alone to complete the water adding action. The operation of opening and closing and adding water is convenient and quick, and the user experience is good; the filter tray can be limited effectively at up and down, left and right, front and back by arranging a pull-out bracket. The limit position makes the pull-out performance of the filter tray reliable and the filter tray will not loose or fall during the pull-out process, which improves the user experience. The pull-out bracket also has a buckle function for the filter tray, which effectively prevents the filter tray from being pulled out by misoperation.

The control member is detachably arranged on the baking tray main body. When the control member is separated from the baking tray main body, other electrical members such as the motor in the fan assembly will be disconnected from the control member, and at the same time, the baking tray main body is not charged to further ensure that the motor and other electrical members are in a power-off state, so as to avoid safety accidents such as electric shock during cleaning and maintenance, and greatly improve the safety of the smokeless baking tray. Since the main electrical members are disassembled with the control members, the cleaning operation is more convenient, and the cleaning effect is better.

In addition, the fan assembly is modularized and can be detachably installed in the fan assembly accommodating cavity at the bottom of the baking tray main body, so that the fan assembly is detachable from the baking tray main body and can be removed at least during cleaning and maintenance to avoid water damage to the electrical members in the fan assembly, so as to effectively ensure the service life of the fan assembly, its reliable performance, and facilitate more comprehensive cleaning and maintenance operations. When the fan assembly has problems or failures, the detachable structure can be easily replaced. The fan assembly is convenient and quick to operate. Further, the fan assembly housing in the fan assembly is tightly and sealedly matched with the fan assembly accommodating cavity by the sealing member, so that the installation of the fan assembly is stable and reliable while effectively preventing air leakage, and the disassembly and assembly operation is convenient and quick. In order to solve the power connection problem of the fan assembly, the electric connection male connector is provided to be plugged into the electric connection female connector in the control assembly to embody the electrical connection between the motor and the control assembly to ensure the normal use of the fan assembly.

### BRIEF DESCRIPTION OF THE DRAWINGS

FIG. 1 is an exploded view of the smokeless baking tray in an embodiment of the present disclosure.

FIG. 2 and FIG. 3 are partial cross-sectional views of different positions of the filter tray in an embodiment of the present disclosure.

FIG. 4 is a schematic structural diagram of an electric control mechanism in an embodiment of the present disclosure.

FIG. 5 is an exploded view of the baking tray main body and fan assembly in an embodiment of the present disclosure.

FIG. 6 is a partial cross-sectional view of the position of the fan assembly in an embodiment of the present disclosure.

FIG. 7 is a schematic structural diagram of the fan assembly in an embodiment of the present disclosure.

FIG. 8 is an exploded view of the baking tray main body and the connecting member in an embodiment of the present disclosure.

FIG. 9 is a schematic diagram of the structure of the connecting member in an embodiment of the present disclosure.

FIG. 10 is a partial cross-sectional view of the connecting part cooperating with the cover in an embodiment of the present disclosure.

FIG. 11 is a partial exploded view of the smokeless baking tray in an embodiment of the present disclosure.

FIG. 12 is a partial cross-sectional view of the internal circuit in the power-on state in an embodiment of the present disclosure.

FIG. 13 is a partial cross-sectional view of the internal circuit in the power-off state in an embodiment of the present disclosure.

FIG. 14 is a partial cross-sectional view of the position of the cushion block in an embodiment of the present disclosure.

FIG. 15 is a schematic diagram of the structure of the baking plate in an embodiment of the present disclosure.

FIG. 16 is a cross-sectional view of the baking plate in an embodiment of the present disclosure.

### DETAILED DESCRIPTION OF THE EXEMPLARY EMBODIMENTS

The present disclosure will be further described below in conjunction with the drawings and embodiments.

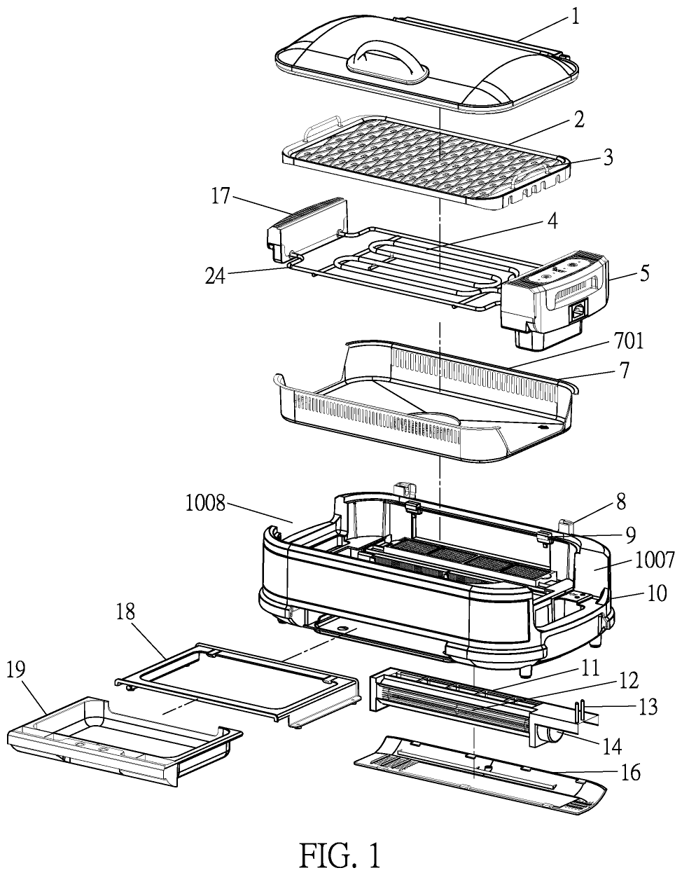

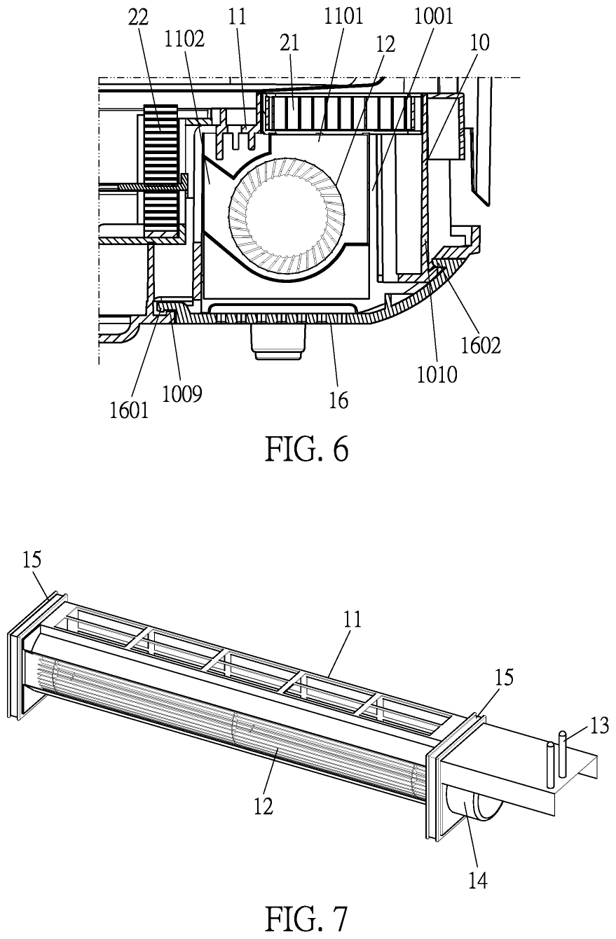

Referring to FIGS. 1-7, a smokeless baking tray of the present disclosure includes a baking tray main body 10, and a fan assembly and a control assembly that are electrically connected to each other. A pull-out sliding filter tray 19 and a pull-out bracket 18 are provided on the baking tray main body 10, and the pull-out bracket 18 is located on the filter tray 19. First limiting portions 1004 is respectively provided on two inner sides of the baking tray main body 10 and second limiting portions 1801 are respectively provided on two sides of the pull-out bracket 18, and the second limiting portion 1801 corresponds upon the first limiting portion 1004. A first sliding gap is between the first limiting portion 1004 and the second limiting portion 1801. Side wings 1901 are respectively provided on two sides of the pull-out sliding filter tray 19 and slide in the first sliding gap along with the pull-out sliding filter tray 19. The side wings 1901 are supported on the top of the first limiting portion 1004 and the second limiting portion 1801 acts a limiting function on the top of the side wings 1901. The mutual limiting cooperation of the first limiting portion 1004 and the second limiting portion 1801 limits the up and down movement of the filter tray 19, effectively preventing the filter tray 19 from loosening and overturning during the pulling process, so that the pull-out performance of the filter tray 19 is more reliable. The fan assembly and the control assembly are respectively and detachably arranged on the baking tray main body 10. The fan assembly comprises a motor 14 and an electrical connection male connector 13 that are electrically connected to each other, and the motor 14 is configured to drive a wind wheel, so that negative pressure is generated inside the baking tray main body 10, and then a circulating air flow is generated to treat oil fume. The control assembly comprises a control main board and an electrical connection female connector 20 that are electrically connected to each other, and the control main board controls the work of various electrical components on the smokeless baking tray. When the control assembly is assembled on the baking tray main body 10, the electrical connection male connector 13 and the electrical connection female connector 20 are plugged into each other to embody the electrical connection of the motor 14 and the control main board, and at this time, the motor 14 can be connected to the power supply to work. When the control assembly is separated from the baking tray main body 10, the electrical connection male connector 13 is separated from the electrical connection female connector 20, and the motor 14 is powered off, and at this time, the motor 14 cannot work, and the baking tray main body 10 is guaranteed not to be powered.

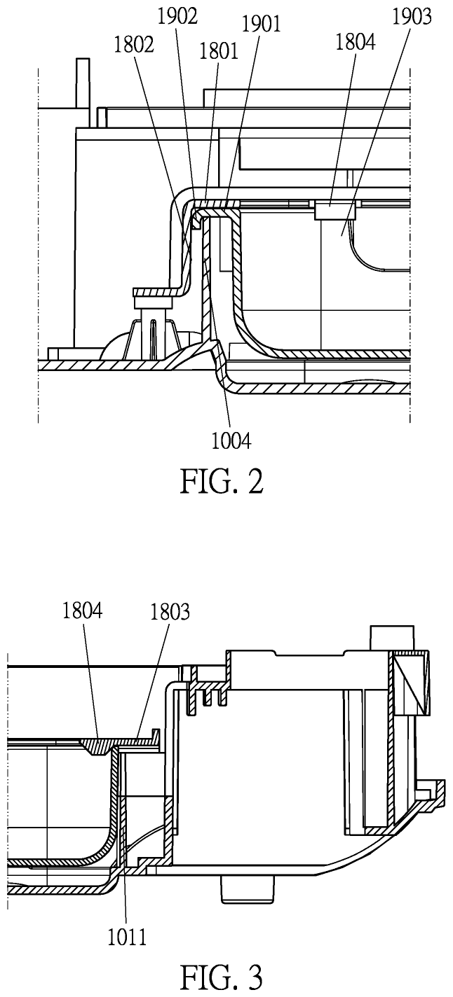

Further, referring to FIGS. 2 and 3, third limiting portions 1802 are respectively provided at two sides of the the pull-out bracket 18, and a second sliding gap is between the first limiting portion 1004 and the third limiting portion 1802. A folded edge 1902 is at an end of the side wing 1901 and slides in the second sliding gap along with the pull-out sliding filter tray 19. The first limiting portion 1004 acts a limiting function at an inner side of the folded edge 1902 and the third limiting portion 1802 acts a limiting function at an outer side of the folded edge 1902. The first limiting portion 1004 and the third limiting portion 1802 cooperate with each other to limit the left and right movement of the filter tray 19 and effectively prevent the filter tray 19 from alternating left and right during the pulling process.

A buckle 1804 is formed on the rear side of the pull-out bracket 18, and the buckle 1804 limits the filter tray 19 from sliding in the opening direction in the closed state to prevent the filter tray 19 from slipping out by misoperation in the closed state. A fourth limiting portion 1011 is formed at the inner rear side of the baking tray main body 10, and the rear sidewall of the filter tray 19 is limited between the buckle 1804 and the fourth limiting portion 1011 to limit the front and back movement of the filter tray 19 in the closed state, so that the closed state of the filter tray 19 is more stable. Specifically, the buckle 1804 has a front guiding portion on the front side and a rear guiding portion on the back, and the front and rear guiding portions are inclined or curved. When the filter tray 19 is closed, the front guiding portion guides the rear sidewall of the filter tray 19 to pass the buckle 1804, and when the filter tray 19 is opened, the rear guiding portion guides the rear sidewall of the filter tray 19 to pass the buckle 1804. The rear side of the pull-out bracket 18 is formed with an elastically swinging connecting block 1803, and the buckle 1804 is set on a front end of the connecting block 1803 and is elastically swinging with the connecting block 1803. When the force applied to the filter tray 19 is large enough, the filter tray 19 can pass over the buckle 1804.

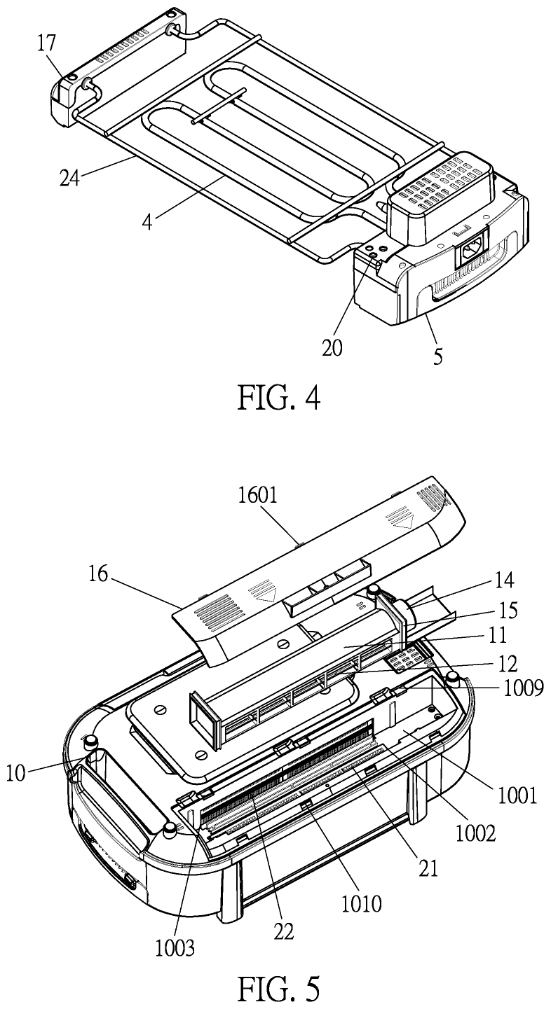

Further, referring to FIGS. 4-7, the bottom of the baking tray main body 10 is provided with a fan assembly accommodating cavity 1001 for accommodating the fan assembly, and the fan assembly also includes a fan assembly housing 11, and the motor 14 and the electrical connection male connector 13 are respectively arranged in the fan assembly housing 11. A sealing member 15 is provided on an outer sidewall of the fan assembly housing 11, and the outer sidewall of the fan assembly housing 11 is sealed and tightly fitted with the fan assembly accommodating cavity 1001 by the sealing member 15. The sealing cooperation can effectively prevent air leakage, and the close fit can ensure that the installation of the fan assembly is stable and reliable.

The control assembly includes a control box body 5, and a control main board and the electrical connection female connector 20 are respectively arranged in the inner cavity of the control box body 5. The top side of the baking tray main body 10 is formed with a first accommodating cavity 1007 for accommodating the control box body 5. The top of the electrical connection male connector 13 protrudes from the bottom of the first accommodating cavity 1007, and corresponds to the electrical connection female connector 20 up and down. The control box body 5 is embedded in the first accommodating cavity 1007 from top to bottom, and the electrical connection male connector 13 is plugged with the electrical connection female connector 20 following the structure. Specifically, the electrical connection male connector 13 is a pin extending upwards and passes through the corresponding through hole on the fan accommodating cavity 1001 from bottom to top, and then is plugged with the electrical connection female connector 20 to embody the electrical connection of the motor 14 and the control member.

Referring to FIG. 4, the electrical control assembly in the smokeless baking tray includes a control assembly and a heating assembly. The heating assembly and the control assembly are fixedly connected to each other, and the heating assembly is combined or separated with the control assembly and the baking tray main body 10. The heating assembly includes the electric heating pipe 4 electrically connected to the control main board, and the control main board controls whether the electric heating pipe 4 works or not. Specifically, the control assembly is fixedly connected with a fixing bracket 24, and the electric heating tube 4 is supported on the fixing bracket 24 to prevent the electric heating tube 4 from falling and deforming. The control assembly is located at one end of the fixing bracket 24, and the other end of the fixing bracket 24 is provided with a carrying box 17. When the user needs to disassemble or assemble the electrical control assembly, both hands can act on a control box body 5 and the carrying box 17 respectively, which makes the disassembly and assembly of the control assembly more convenient. A second accommodating cavity 1008 for accommodating the carrying box 17 is provided at the other side of the top of the baking tray main body 10. When the control assembly is assembled with the baking tray main body 10, the carrying box 17 is embedded in the second accommodating cavity 1008 from top to bottom, and the assembly structure is stable and reliable.

The inner cavity of the fan assembly housing 11 is provided with a wind wheel 12 in position for rotating, and the side of the fan assembly housing 11 is provided with an air inlet 1101 and an air outlet 1102 that communicate with the wind wheel 12. The motor 14 is fixedly arranged on the fan assembly housing 11, and an output shaft of the motor 14 is connected to the wind wheel 12 in transmission. At least one sealing member 15 is located at one end of the air inlet 1101 and the air outlet 1102, and at least another sealing member 15 is located at the other end of the air inlet 1101 and the air outlet 1102 to prevent the air inlet 1101 and the air outlet 1102 from air leakage. The sealing member 15 is soft and elastic, which effectively buffers the fan assembly housing 11, and therefore has the functions of shock absorption and noise reduction. The inner wall of the fan assembly accommodating cavity 1001 is provided with an air inlet groove 1002 in communication with the air inlet 1101 and an air outlet groove 1003 in communication with the air outlet 1102. The air inlet groove 1002 is provided with a first oil smoke filter layer 21, and the air outlet groove 1003 is provided with a second oil smoke filter layer 22. The first and second oil smoke filter layers respectively and effectively filter oil smoke to avoid oil smoke affecting the normal operation of fan assembly members.

The sealing member 15 is an annular sealing ring sleeved on the outside of the fan assembly housing 11. More than one sealing rib is protruding outward on the outer sidewall of the sealing member 15, and the sealing rib is squeezed against the inner sidewall of the fan assembly accommodating cavity 1001 to make the fan assembly housing 11 and the fan assembly accommodating cavity 1001 effectively sealed and tightly fitted. A removable bottom cover 16 is provided at the opening of the fan assembly accommodating cavity 1001. A first buckle 1601 is formed on one side edge of the bottom cover 16, and a second buckle 1602 is formed on the other side edge of the bottom cover 16. One opening edge of the fan assembly accommodating cavity 1001 is formed with a first locking position 1009, and the other opening edge of the fan assembly accommodating cavity 1001 is formed with a second locking position 1010. When the bottom cover 16 closes the fan assembly accommodating cavity 1001, the first buckle 1601 and the first locking position 1009 are buckled together, and the second buckle 1602 and the second locking position 1010 are buckled together.

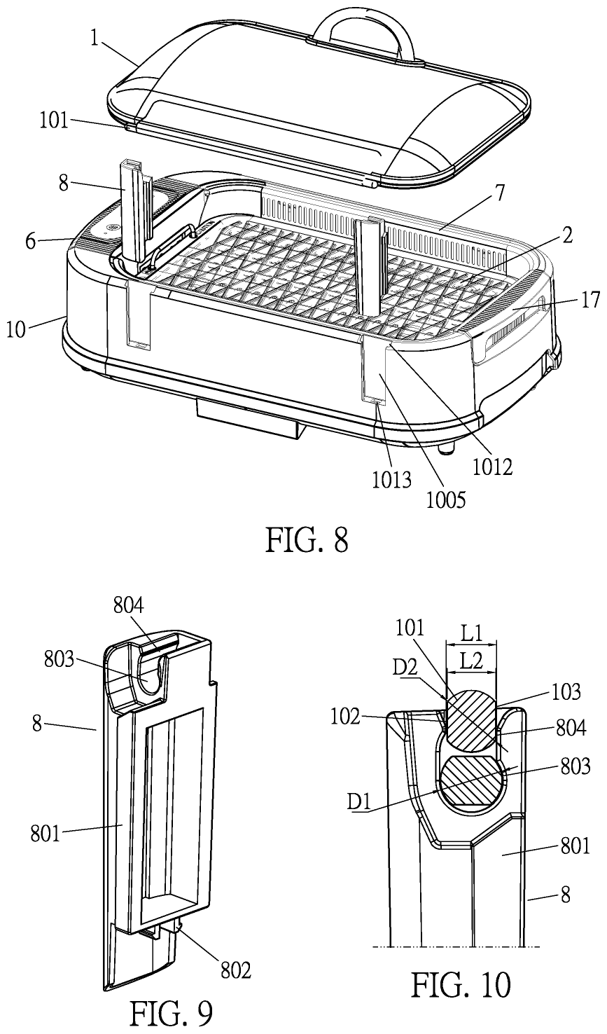

Further, referring to FIGS. 8-10, the side of the baking tray main body 10 is provided with two connecting members 8 and installation grooves 1005 are correspondingly provided to the connecting parts 8. The outer side and the top of the installation groove 1005 are respectively opened and arranged, and the inner side of the connecting member 8 is at least partially detachably inserted into the installation groove 1005 from top to bottom to embody the detachable assembly of the connecting member 8 and the baking tray main body 10. The connecting member 8 can be used independently, or fitted to the corresponding cover 1 and hinged, and the cover 1 is hinged with the baking tray main body 10 by a fitted connecting member 8. When the user needs to use the cover 1 for the application of the smokeless baking tray, the connecting member 8 can be hinged with the cover 1 (as shown in FIG. 9). When the user does not need to use the cover 1 for the application of the smokeless baking tray, in order to prevent the connecting member 8 that can be hinged with the cover 1 from affecting the normal use of the baking tray main body 10, the connecting member 8 can be used independently (the hinged structure of the connecting member 8 and the cover 1 is removed).

The two sides of the installation groove 1005 are respectively formed with an anti-drop groove 1012, the two sides of the connecting member 8 are respectively formed with a protruding strip 801 matched with the anti-drop groove 1012, and the protruding strips 801 are inserted into the anti-drop grooves 1012. The mutual cooperation of the anti-drop grooves 1012 and the protruding strips 801 effectively prevents the connecting member 8 from being laterally separated from the baking tray main body 10, which makes the assembly performance more reliable. The bottom of the installation groove 1005 is provided with a connecting buckle hole 1013, the bottom of the connecting member 8 is provided with a connecting clip 802, the connecting clip 802 is clipped with the connecting buckle hole 1013, and the connecting buckle hole 1013 and the connecting clip 802 are matched with each other to make the assembly and connection of the connecting member 8 and the baking tray main body 10 more stable and prevent the connecting member 8 from being separated from the baking tray main body 10 by misoperation.

The top of the connecting member 8 hinged to the cover 1 is formed with a hinge hole 803 extending laterally and an installation opening 804 in communication with the hinge hole 803. The inner diameter D1 of the hinge hole 803 is greater than the width L1 of the installation opening 804. The hinge shaft 101 on the cover 1 is rotatably assembled in the hinge hole 803 through the installation hole 804. Since the inner diameter D1 of the hinge hole 803 is greater than the width L1 of the installation hole 804, the installation hole 804 can limit the hinge shaft 101 to the extent to prevent the cover 1 from being disengaged from the connecting member 8 by misoperation. Specifically, the outer diameter D2 of the hinge shaft 101 is slightly smaller than the inner diameter D1 of the hinge hole 803. The hinge shaft 101 is provided with a first cutting surface 102 and a second cutting surface 103 that cooperate in parallel with each other, and the distance L2 between the first cutting surface 102 and the second cutting surface 103 is slightly smaller than the width L1 of the installation opening 804. When the cover 1 needs to be installed, the hinge shaft 101 is rotated to the inner wall where the first cutting surface 102 and the second cutting surface 103 respectively correspond to the installation opening 804 (at this time, the cover 1 is in a vertical state), and then the hinge shaft 101 can easily pass through the installation opening 804 and enter the hinge hole 803, which makes the cover 1 easy to disassemble and assemble, and has reliable performance.

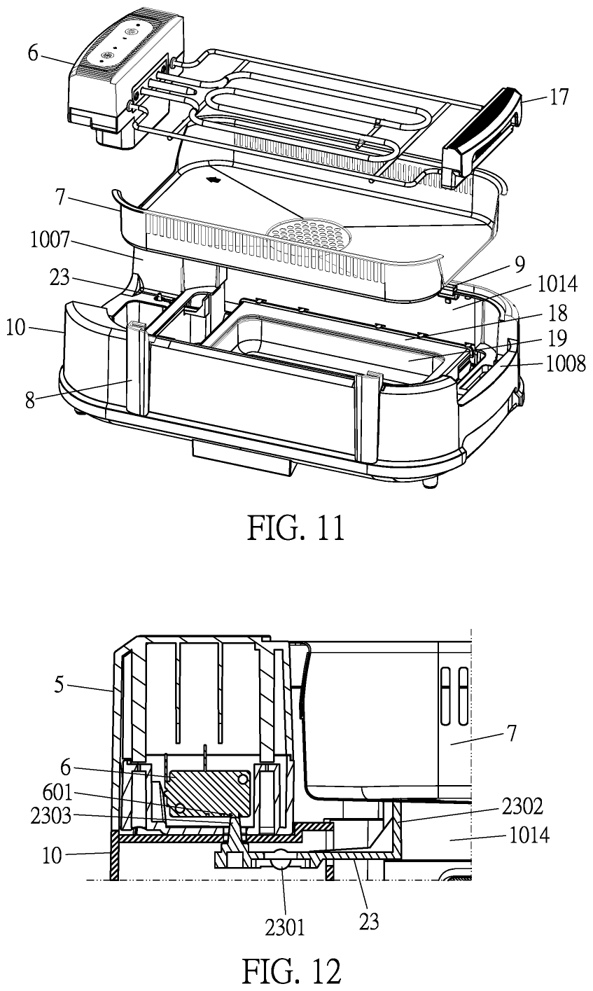

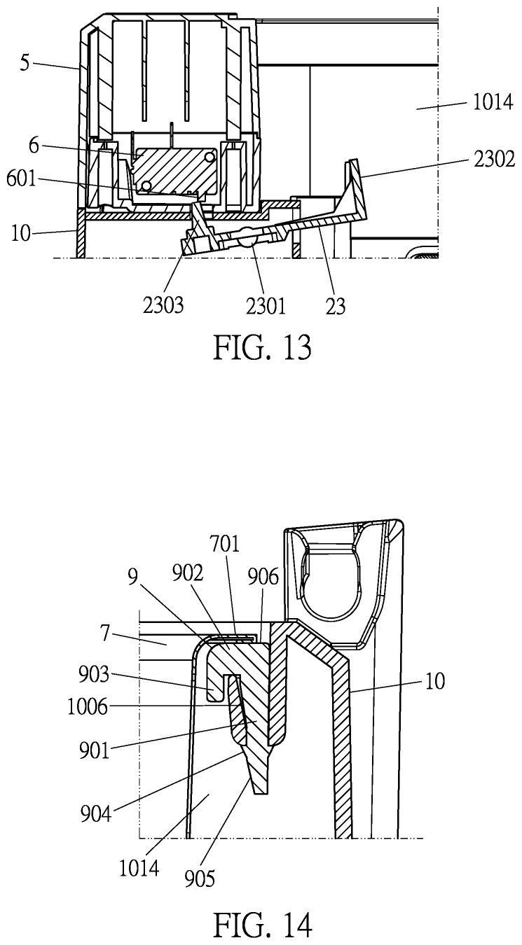

Further, referring to FIGS. 11-13, the baking tray main body 10 is provided with a detachable reflecting tray 7 and a safety switch 23 with a certain degree of freedom of movement. The control assembly also includes a micro switch 6 for controlling power-on/power-off state of the internal circuit. The reflecting tray 7 touches the switch key 601 on the micro switch 6 through the safety switch 23 to make the internal circuit enter the power-on state. The safety switch 23 with a certain degree of freedom is arranged inside the baking tray main body 10. When the reflecting tray 7 is installed on the baking tray main body 10, the reflecting tray 7 touches the switch key 601 on the micro switch 6 through the safety switch 23 to make the internal circuit enter the power-on state, and the smokeless baking try can work normally. When the reflecting tray 7 is not installed in the baking tray main body 10, the reflecting tray 7 cannot touch the switch key 601 on the micro switch 6 through the safety switch 23, resulting in the internal circuit being in the disconnected state, and the smokeless baking tray cannot work to avoid some safety accidents.

The safety switch 23 is positioned and rotated relative to the baking tray main body 10. By using the lever principle, the reflecting tray 7 is pressed to act on one end of the safety switch 23, and the other end of the safety switch 23 is pressed to act on the switch key 601. A convex shaft 2301 rotatably connecting the baking tray main body 10 is provided on a middle part of the safety switch 23; that is, the middle part of the safety switch 23 is positioned and rotated on baking tray main body 10. A protrusion 2302 pressed by the reflecting tray 7 is provided on one end of the safety switch 23, and extends upward relative to the main body of the safety switch 23. A pin 2303 for triggering the switch key 601 is provided on the other end of the safety switch 23, the pin 2303 extends upward relative to the main body of the safety switch 23, and the extension direction of the protrusion 2302 and the pin 2303 are the same. Specifically, the pin 2303 at least partially protrudes from the corresponding through hole on the first accommodating cavity 1007, a through hole corresponding to the switch key 601 is formed on the outer bottom wall of the control box body 5, and the portion of the safety switch 23 protruding from the first accommodating cavity 1007 passes through the corresponding through hole to touch the switch key 601 to ensure the effective connection between the safety switch 23 and the micro switch 6. The inner side of the baking tray main body 10 is provided with a third accommodating cavity 1014 for accommodating the reflecting tray 7. The protrusion 2302 at least partially protrudes from the third accommodating cavity 1014.

Further, referring to FIG. 14, there are four cushion blocks 9 evenly distributed between the reflecting tray 7 and the baking tray main body 10. The reflecting tray 7 is detachably supported on the top of the cushion block 9, and the reflecting tray 7 is not in contact with the baking tray main body 10. The cushion block 9 plays an effective anti-vibration, balance, buffer, sound-absorbing, and heat-insulating effect on the reflecting tray 7, which effectively improves the user experience and increases the product safety factor.

The cushion block 9 includes a plug-in portion 901, a supporting portion 902 and a blocking portion 903. Installation holes 1006 corresponding to the plug-in portion 901 are provided on the baking tray main body 10 and the plug-in portion 901 is inserted into the corresponding installation hole 1006. The extension edge 701 of the top opening edge of the reflecting tray 7 extends outward and is supported on the top of the supporting portion 902. The blocking portion 903 is located between the outer sidewall of the reflecting tray 7 and the outer sidewall of the installation hole 1006, which effectively prevents the outer sidewall of the reflecting tray 7 from colliding with the inner wall of the baking tray main body 10. Specifically, the inner wall of the third accommodating cavity 1014 is formed with a supporting step, and the reflecting tray 7 is relatively supported on the supporting step. The installation hole 1006 is a through-hole structure, and the lower side of the plug-in portion 901 at least partially penetrates the installation hole 1006 downwards and the parts of the front and rear sides where are penetrated are respectively provided with barbs 904. The barbs 904 are inverted at the bottom of the installation hole 1006 to effectively prevent the cushion block 9 from loosening. A guide surface 905 is provided on the lower side of the plug-in portion 901 to guide the plug-in portion 901 to be inserted in the installation hole 1006, and the guide surface 905 is inclined or curved. The cushion block 9 is made of soft rubber material with poor thermal conductivity, and is preferably made of silicone material. The cushion block 9 can compensate for processing errors to effectively ensure the balance of the installation of the reflecting tray 7.

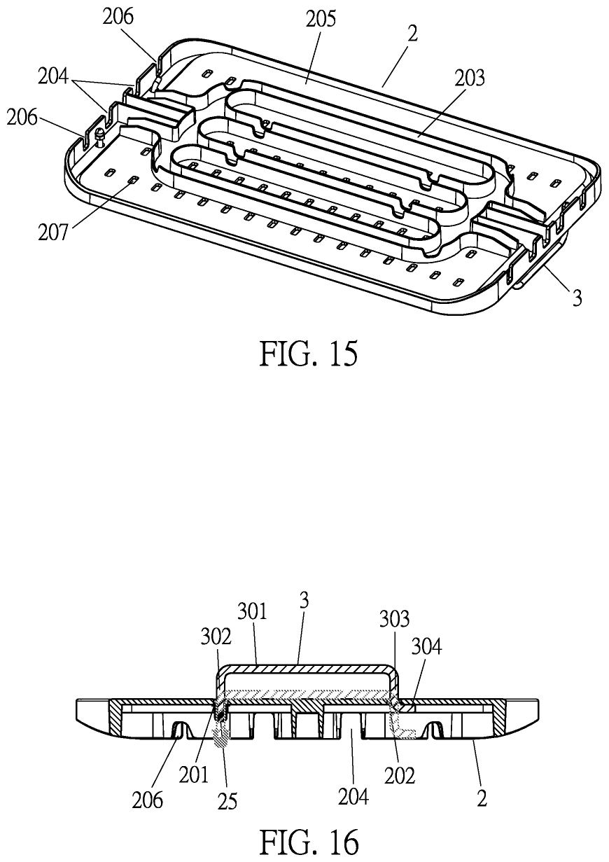

Further, referring to FIGS. 15 and 16, the smokeless baking tray also includes a baking plate 2 integrally formed of metal material, the top surface of which is used to place and heat ingredients. A handle 3 that is capable of moving up and down freely is provided on both sides of the baking plate 2. The handle 3 at least rises to a position suitable for the user to lift relative to the baking plate 2 when the baking plate 2 is lifted, and the handle 3 is at least lowered to a position that does not hinder user's actions relative to the baking plate 2 when the baking plate 2 is used. It can be seen that the structure effectively solves the problem that the handle 3 hinders the user's operation on the basis of not affecting the convenient lifting of the baking plate 2, thereby improving the user's experience.

The baking plate 2 is provided with a first limiting through hole 201 and a second limiting through hole 202. The handle 3 includes a handle portion 301 for the user to hold, a first connecting rod 302 and a second connecting rod 303. The first connecting rod 302 is movably inserted into the first limiting through hole 201, and the second connecting rod 303 is movably inserted into the second limiting through hole 202; both ends of the handle portion 301 are respectively connected to the first connecting rod 302 and the second connecting rod 303. The first connecting rod 302 and the second connecting rod 303 are respectively provided with an anti-dropping part for avoiding detaching from the corresponding limiting through hole. When the baking plate 2 needs to be lifted, the user holds the handle portion 301 on the handle 3, the baking plate 2 sinks relative to the handle 3 and is finally supported on the anti-dropping part, so the user can use the handle 3 to move the baking plate 2. When the baking plate 2 is in use, the handle 3 sinks relative to the baking plate 2 under the action of gravity until the handle portion 301 is supported on the top surface of the baking plate 2, so that the handle 3 will not affect the user. Specifically, the anti-dropping part on the first connecting rod 302 is an anti-dropping nut 25 provided at the end of the first connecting rod 302; the anti-dropping part on the second connecting rod 303 is an elbow 304 formed by bending the second connecting rod 303 (in addition, the anti-dropping part on the first connecting rod 302 and the second connecting rod 303 can be the anti-dropping nut 25, or the first connecting rod 302 and the second connecting rod 303 are the elbow 304 formed by respectively bending the first connecting rod 302 and the second connecting rod 303).

The bottom of the baking plate 2 is formed with a first accommodating groove 203 for accommodating the electric heating tube 4 and two first notches 204 respectively in communication with the first accommodating groove 203. The first accommodating groove 203 is located inside the bottom of the baking plate 2 and the structural shape is matched with the circuitous electric heating tube 4. The two ends of the electric heating tube 4 respectively pass through the first notches 204 to connect to the control main board in the control assembly. The first accommodating groove 203 has a left-right symmetrical structure, and the first notches 204 are symmetrically provided on the baking plate 2. The electric heating tube 4 can be installed on the baking plate 2 in a positive and negative manner, which improves the convenience of installation of the baking plate 2. In addition, a second accommodating groove 205 for accommodating the fixing bracket 24 and second notches 206 in communication with the second accommodating groove 205 are formed at the bottom of the baking plate 2. One end of the fixing bracket 24 passes through the corresponding second notch 206 and then connects to the control box body 5, and the other end of the fixing bracket 24 penetrates through the corresponding second notch 206 and then connects to the carrying box 17.

A number of oil holes 207 for draining oil are provided on the baking plate 2; a number of anti-slip ribs are integrally formed on the top surface of the baking plate 2, and the whole of the anti-slip ribs are interwoven in a net shape.

The above are the preferred solutions of the present disclosure, showing and describing the basic principles, main features and advantages of the present disclosure. Those skilled in the art should understand that the present disclosure is not limited by the above-mentioned embodiments. The above-mentioned embodiments and the description only illustrate the principles of the present disclosure, and the present disclosure will have various options without departing from the spirit and scope of the present disclosure and changes and improvements fall within the scope of the present disclosure. The scope of protection claimed by the present disclosure is defined by the appended claims and their equivalents.

What is claimed is:

1. A smokeless baking tray, comprising a baking tray main body (10), and a fan assembly and a control assembly that are electrically connected to each other; wherein: a pull-out sliding filter tray (19) and a pull-out bracket (18) are provided on the baking tray main body (10); a first limiting portion (1004) is provided on the baking tray main body (10) and a second limiting portion (1801) is provided on the pull-out bracket (18), a first sliding gap is between the first limiting portion (1004) and the second limiting portion (1801); a side wing (1901) is provided on the pull-out sliding filter tray (19) and slides in the first sliding gap along with the pull-out sliding filter tray (19); the side wing (1901) is supported on the first limiting portion (1004) and the second limiting portion (1801) acts a limiting function on the top of the side wing (1901); the fan assembly and the control assembly are respectively and detachably arranged on the baking tray main body (10), wherein the fan assembly comprises a motor (14) and an electrical connection male connector (13) that are electrically connected to each other; the control assembly comprises a control main board and an electrical connection female connector (20) that are electrically connected to each other; when the control assembly is assembled on the baking tray main body (10), the electrical connection male connector (13) and the electrical connection female connector (20) are plugged into each other to embody the electrical connection of the motor (14) and the control main board; when the control assembly is separated from the baking tray main body (10), the electrical connection male connector (13) is separated from the electrical connection female connector (20), and the motor (14) is powered off.

2. The smokeless baking tray according to claim 1, wherein a fan assembly accommodating cavity (1001) for accommodating the fan assembly is provided on baking tray main body (10), wherein the fan assembly further comprises a fan assembly housing (11), and a sealing member (15) is provided on the fan assembly housing (11), and the fan assembly housing (11) is sealed and tightly matched with the fan assembly accommodating cavity (1001) by the sealing member (15).

3. The smokeless baking tray according to claim 2, wherein a wind wheel (12) in position for rotating is provided on the fan assembly housing (11), and an air inlet (1101) and an air outlet (1102) in communication with the wind wheel (12) are provide at a side of the fan assembly housing (11); the motor (14) is fixedly arranged on the fan assembly housing (11), and an output shaft of the motor (14) is connected to the wind wheel (12) in transmission; an air inlet groove (1002) in communication with the air inlet (1101) and an air outlet groove (1003) in communication with the air outlet (1102) are provided on the fan assembly accommodating cavity (1001); and the air inlet groove (1002) and/or the air outlet groove (1003) are provided with an oil smoke filter layer.

4. The smokeless baking tray according to claim 1, wherein a third limiting portion (1802) is provided on the pull-out bracket (18), and a second sliding gap is between the first limiting portion (1004) and the third limiting portion (1802); a folded edge (1902) is at an end of the side wing (1901) and slides in the second sliding gap along with the pull-out sliding filter tray (19); and the first limiting portion (1004) acts a limiting function at an inner side of the folded edge (1902) and the third limiting portion (1802) acts a limiting function at an outer side of the folded edge (1902).

5. The smokeless baking tray according to claim 1, wherein more than one connecting member (8) is provided on the baking tray main body (10), and installation grooves (1005) are correspondingly provided to the connecting member (8); the connecting member (8) is at least partially detachably inserted into the installation groove (1005) to embody detachable assembly of the connecting member (8) and the baking tray main body (10); the connecting member (8) is used independently, or fitted to and hinged with a corresponding cover (1), and the cover (1) is hinged with the baking tray main body (10) by a fitted connecting member (8).

6. The smokeless baking tray according to claim 1, wherein a detachable reflecting tray (7) and a safety switch (23) with a certain degree of freedom of movement are provided on the baking tray main body (10); the control assembly also comprises a micro switch (6) for controlling power-on/power-off state of an internal circuit; and the reflecting tray (7) touches a switch key (601) on the micro switch (6) through the safety switch (23) to make the internal circuit enter the power-on state.

7. The smokeless baking tray according to claim 6, wherein the safety switch (23) is positioned and rotated relative to the baking tray main body (10), the reflecting tray (7) is pressed to act on one end of the safety switch (23), and the other end of the safety switch (23) is pressed to act on the switch key (601); a convex shaft (2301) for rotatably connecting the baking tray main body (10) is provided on a middle part of the safety switch (23), and a protrusion (2302) pressed by the reflecting tray (7) is provided on one end of the safety switch (23) and a pin (2303) for triggering the switch key (601) is provided on the other end of the safety switch (23).

8. The smokeless baking tray according to claim 6, wherein a cushion block (9) is arranged between the reflecting tray (7) and the baking tray main body (10), the reflecting tray (7) is detachably supported on the cushion block (9), and the reflecting tray (7) is not in contact with the baking tray main body (10).

9. The smokeless baking tray according to claim 8, wherein the cushion block (9) comprises a plug-in portion (901), a supporting portion (902) and a blocking portion (903); an installation hole (1006) is provided on the baking tray main body (10), the plug-in portion (901) is inserted into the installation hole (1006); an extension edge (701) on the reflecting tray (7) is supported on the supporting portion (902); and the blocking portion (903) is located between an outer wall of the reflecting tray (7) and an outer wall of the installation hole (1006).

10. The smokeless baking tray according to claim 1, further comprising a baking plate (2), wherein a handle (3) that is capable of moving up and down freely is provided on the baking plate (2); the handle (3) at least rises to a position suitable for the user to lift relative to the baking plate (2) when the baking plate (2) is lifted, and the handle (3) is at least lowered to a position that does not hinder user's actions relative to the baking plate (2) when the baking plate (2) is used.
